(19) United States
(12) Patent Application Publication
(10) Pub. No.: US 2001/0043172 A1
(43) Pub. Date: Nov. 22, 2001

(54) Field emission display

(76) Inventors: James M. McGrath, South Yarmouth, MA (US); Alan Palevsky, Wayland, MA (US); Clifford Johnson, Lunenburg, MA (US); Gregory E. Gott, Rockland, MA (US); Helmut Lelke, Southborough, MA (US)

Correspondence Address: DALY, CROWLEY & MOFFORD, LLP, SUITE 101, 275 TURNPIKE STREET, CANTON, MA, 02021-2310, US

(21) Appl. No.: 09/814,545

(22) Filed: Mar. 22, 2001

Related U.S. Application Data
(62) Division of application No. 09/318,387, filed on May 25, 1999.
Application No. 09/318,387 is a division of application No. 08/918,275, filed on Aug. 25, 1997, now abandoned.

(51) Int. Cl. G09G 3/22

(52) U.S. Cl. 345/75.2

(57) ABSTRACT

A method for forming images on a display having a matrix of rows and columns of pixels is provided. Such method comprises the steps of: successively addressing the rows of pixels, each one of the rows of pixels being addressed for a predetermined addressing period of time. During each predetermined addressing period of time, a voltage level is applied to each one of the columns of pixels for a time duration in accordance with image intensity data and changing to a different voltage level during the remaining period of the addressing period of time. The voltage level changes only once during each predetermined addressing period of time. The anode of the display is coupled to a power supply adapted to couple either a relatively high voltage to the anode when such display is to operate in a relatively bright environment or a relatively low voltage when such display is to operate with relatively dim environment. The images are characterized by a gray scale level at each one of the pixels. The gray scale level is modified by a contrast term.

### BACKGROUND OF THE INVENTION

This invention relates generally to field emission displays and more particularly to drive electronics used in such displays.

As is known in the art, field emission displays (FEDs) include an array of field emitting cathodes, a cathodoluminescent anode, and an array of control, or gate, electrodes. Each one of the gate electrodes controls the flow of electrons between a corresponding one of the cathodes and a pixel on the cathodoluminescent anode. In a monochromatic array, each pixel corresponds to either a black or white display luminescence; in a color display each pixel corresponds to a luminous blend of a plurality of, typically three colors arranged as stripes, triad dots or quad dots.

As is also known in the art, the field emission display is typically arranged in a matrix of rows and columns of pixels. In one such display, each pixel includes a cathode made up of a plurality of the cone-shaped, field emitters and a corresponding gate electrode. One such structure is described in U.S. Pat. No. 5,543,691 “Field Emission Display with Focus Grid and Method of Operating Same”, issued Aug. 6, 1996, inventors Alan Palevsky and Peter F. Koufopulos, assigned to the same assigned as the present invention, and incorporated herein by reference.

As is also known in the art, one way of controlling the display of images is to successively address rows of the pixels. Simultaneously with the addressing of each row, the pixels in each of the columns receive gray scale video data. One technique used to process such gray scale video data is suggested in U.S. Pat. No. 5,075,683, issued Dec. 24, 1991, entitled “Method and Device for Controlling a Matrix Screen Displaying Gray Levels Using Time Modulation, inventors Anne Ghis. As suggested therein, during the time a row of pixels is addressed, activation signals are delivered to the columns of pixels for a time duration related to the gray scale video data to obtain a desired light intensity at the addressed row of pixels. Thus, for each addressed row of pixels, a pulse is fed to each one of the columns of pixels in the addressed row, such pulse having a time duration related to the desired gray scale video data intensity level.

### SUMMARY OF THE INVENTION

In accordance with the present invention, a method for forming images on a display having a matrix of rows and columns of pixels is provided. Such method comprises the steps of: successively addressing the rows of pixels, each one of the rows of pixels being addressed for a predetermined addressing period of time. During each predetermined addressing period of time, a voltage level is applied to each one of the columns of pixels for a time duration in accordance with image intensity video data and then changes to a different voltage level during the remaining period of the addressing period of time. The voltage level changes no more than once during each predetermined row addressing period of time.

With such an arrangement, power dissipation in the display is reduced when compared with a system which pulses the columns of pixels during row addressing. That is, with a pulse, such pulse changes levels twice each row addressing period. Because of capacitance effects on the columns, each time the level of the voltage fed to such column changes, power is dissipated. Therefore, by reducing the number of voltage level changes on the columns in half during each row addressing period, i.e., from two voltage level changes per row addressing period to no more than one change voltage level change per row addressing period, power dissipation is reduced by a factor of 2.

In accordance with another feature of the invention, a field emission display is provided including an array of field emitting cathodes, a cathodoluminescent anode, and an array of control, or gate, electrodes. Each one of the gate electrodes controls the flow of electrons between a corresponding one of the cathodes and a pixel on the cathodoluminescent anode. The anode is coupled to a power supply adapted to couple either a relatively high voltage to the anode when such display is to operate in a relatively bright environment or a relatively low voltage when such display is to operate with relatively dim environment.

In accordance with another feature of the invention, a method is provided for forming images on a display having a matrix of rows and columns of pixels. The images are characterized by a gray scale intensity level at each one of the pixels. The method includes the step of producing a series of streams of video data samples. Each stream in the series represents intensity levels of pixels in a corresponding one of the rows of pixels. Each video data sample in the stream represents the intensity level of a corresponding one of the columns of pixels in such corresponding one of the rows of pixels. Each produced video data sample is converted into a gray scale level. The method modifies the gray scale level by a contrast term.

In a preferred embodiment of the invention, the contrast term shift the gray scale level by an operator selected term, A.

In accordance with another feature of the invention, a field emission display is provided including an array of field emitting cathodes, a cathodoluminescent anode, and an array of control, or gate, electrodes. Each one of the gate electrodes controls the flow of electrons between a corresponding one of the cathodes and a pixel on the cathodoluminescent anode. Each one of the pixels includes one of the cathodes, a corresponding one of the control electrodes and the corresponding anode pixel. Each one of the display pixels produces a light intensity in accordance with video data fed to the display system. The video data fed to the display is modified by contrast terms. The modified video data is used to control the intensity of the pixels.

In accordance with another feature of the invention, a method is provided for forming images on a display having a matrix of rows and columns of pixels. The images are characterized by a gray scale intensity level at each one of the pixels. The method includes the steps of producing a series of streams of video data samples. Each stream in the series represents intensity levels of pixels in a corresponding one of the rows of pixels. Each video data sample in the stream represents the intensity level of a corresponding one of the columns of pixels in such corresponding one of the rows of pixels. Each produced video data sample is converted into a gray scale level having a maximum gray scale level, GSL_{MAX}, to produce a non-complemented gray scale level. The method also converts each produced video data sample into the complement of such non-complemented gray scale level by subtracting the non-complemented gray scale level from GSL_{MAX}. The streams of produced non-complemented gray scale levels in first ones of the streams thereof are successively stored during addressing of a first set of rows of pixels and the streams of produced complementary gray scale levels in second ones of the produced series are successively stored during addressing of a second set of rows of pixels, the rows of pixels in the first set being interleaved with the rows of pixels in the second set, the rows of pixels being successively addressed. Each one of the rows of pixels is addressed for a predetermined period of time, T_{ROW}. The stored first and second series of gray scale levels are read from storage, the reading of the first series being interleaved with the reading of the second series. Each one of the read gray scale levels is converted into a time period, T_{COLUMN}, such time period commencing at a time, tₙ, after commencement of the addressing of each of the rows of pixels. During the addressing of the rows of pixels, a voltage level produced at the columns of pixels is switched at the time, tₙ, during each of the row addressing periods of time T_{ROW}.

### BRIEF DESCRIPTION OF THE DRAWING

Other features of the invention, as well as the invention itself, will become more readily apparent when read together with the following detailed description taken together with the accompanying drawings, in which:

FIG. 1 is an diagrammatical sketch of a field emission display in accordance with the invention;

FIG. 1A is an exploded diagrammatical sketch of a portion of an exemplary pixel in the display of FIG. 1, FIG. 1A showing the portion encircled by arrow 1A-1A in FIG. 1;

FIG. 2 is a cross-sectional elevation view of the display of FIG. 1;

FIG. 3 is a cross-sectional simplified sketch of an exemplary one of the pixels of the display of FIG. 1.

FIG. 4 is a block diagram of row-column address drive electronic circuit for addressing the pixels in the display of FIG. 1 in accordance with the invention;

FIG. 5 is a timing diagram of the circuit of FIG. 4 showing the relationship between pixel row addressing and pixel column addressing;

FIG. 5A is a diagram showing the relationship between rows and columns of the pixels used in the display of FIG. 1 and addressed by the electronics of FIG. 4;

FIG. 6 is a timing diagram of the circuit of FIG. 4 showing the relationship between pixel row addressing and pixel column addressing, such timing diagram being useful in understanding the operation of the electronics of FIG. 4.

### DETAILED DESCRIPTION

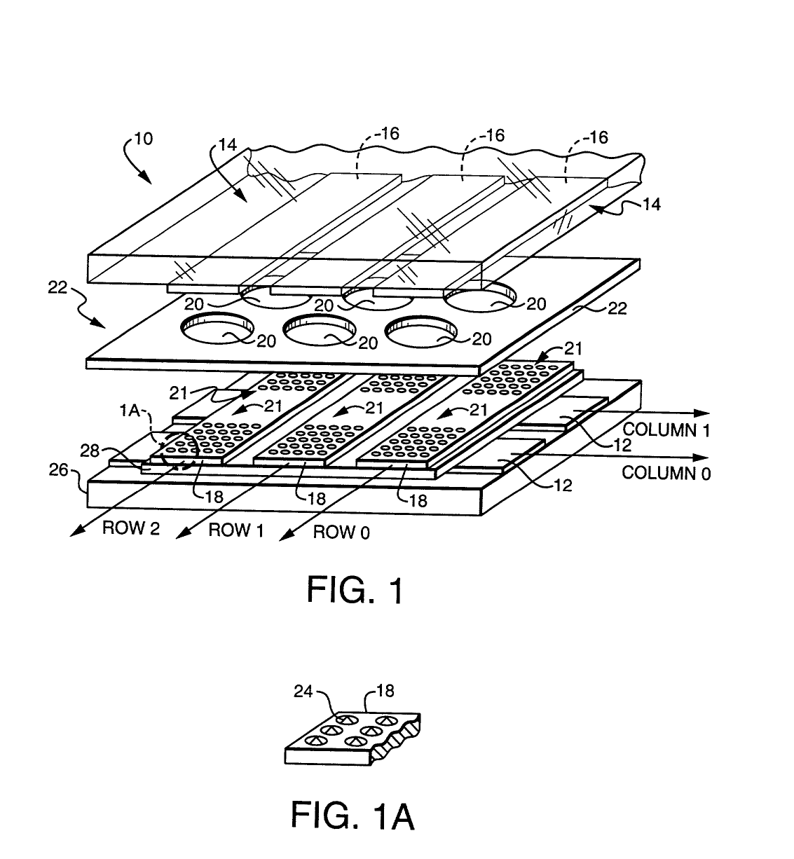

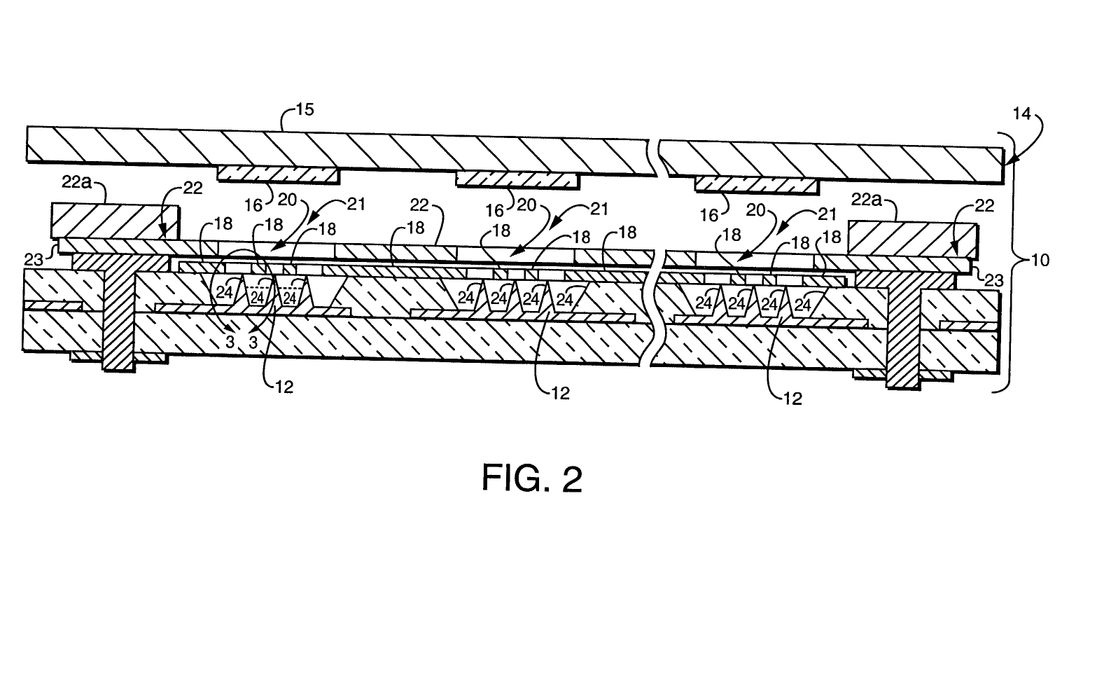

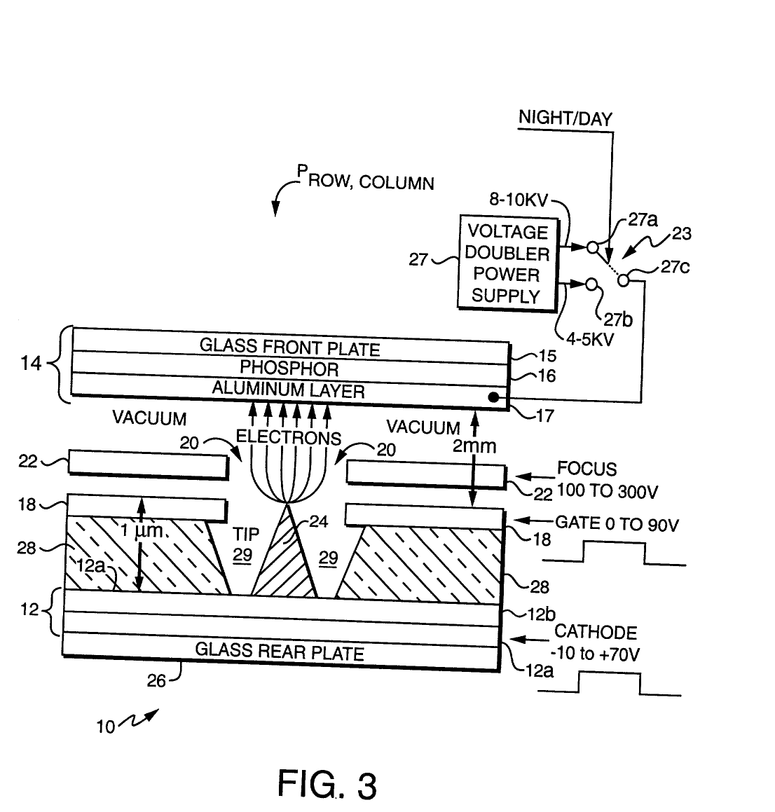

Referring now to FIGS. 1, 1A and 2, a field emission display 10 is shown having: a plurality of cathodes 12, an anode 14 having a plurality of cathodoluminescent stripes or dots 16; a plurality of control, or gate electrodes 18 for controlling the flow of electrons between the cathodes 12 and the anode 14; and a plurality of focusing grids 20, disposed between the anode 14 and the plurality of cathodes 12. Each cathodoluminescent stripe, or dot 16 may be a different one of three colors, as in a color display, or may for the same color, as in a monochromatic display. Each one of the cathodes 12 comprises a plurality of sets 21 of field emitters 24. Each focusing grid 20 is associated with a corresponding one of the sets 21 of the plurality of field emitters 24. Each one of the sets 21 makes up a pixel, P. The plurality of focusing grids 20 comprise an apertured conductive sheet 22. More particularly, the conductive sheet 22 has a plurality of apertures formed therein and arranged in an array in the central, interior region of the sheet 22. Each one of the apertures provides one of the focusing grids 20. Each aperture (i.e., focusing grid 20) is disposed over the corresponding set of field emitters 24. More particularly, each focusing grid 20 is disposed between one of the cathodoluminescent stripes or dots 16 and a set 21 of the field emitters 24. The focusing grid 20 is biased at a voltage greater than the voltage of the field emitters 24 and less than the anode 14. The focusing grid 20 intercepts any very high angle electrodes thereby preventing them from getting to the anode 14, focuses the electrons that are not intercepted to a more localized, i.e., focused region on the anode 14, and, because the electric field in the space between the cathode 12 and the focusing grid 20 is less than the electric field between the focusing grid 20 and the anode 14, the focusing grid 20 increases the shielding, or isolation, between the cathode 12 from the high voltage anode 14, as described in the above referenced U.S. Pat. No. 5,543,691.

The cathodes 12 are disposed on an insulating substrate 26, here glass. The control, or gate electrodes 18 are formed on a layer 28 of insulating material. The outer periphery of sheet 22 is welded to a frame 22a in a manner to be described in co-pending patent application, Ser. No. 08/586,100, entitled “Field Emission Display and Manufacturing Methods”, filed Jan. 16, 1996, Inventors R. Dennis Breen et al., assigned to the same assignee as the present invention, the subject matter thereof being incorporated herein by reference.

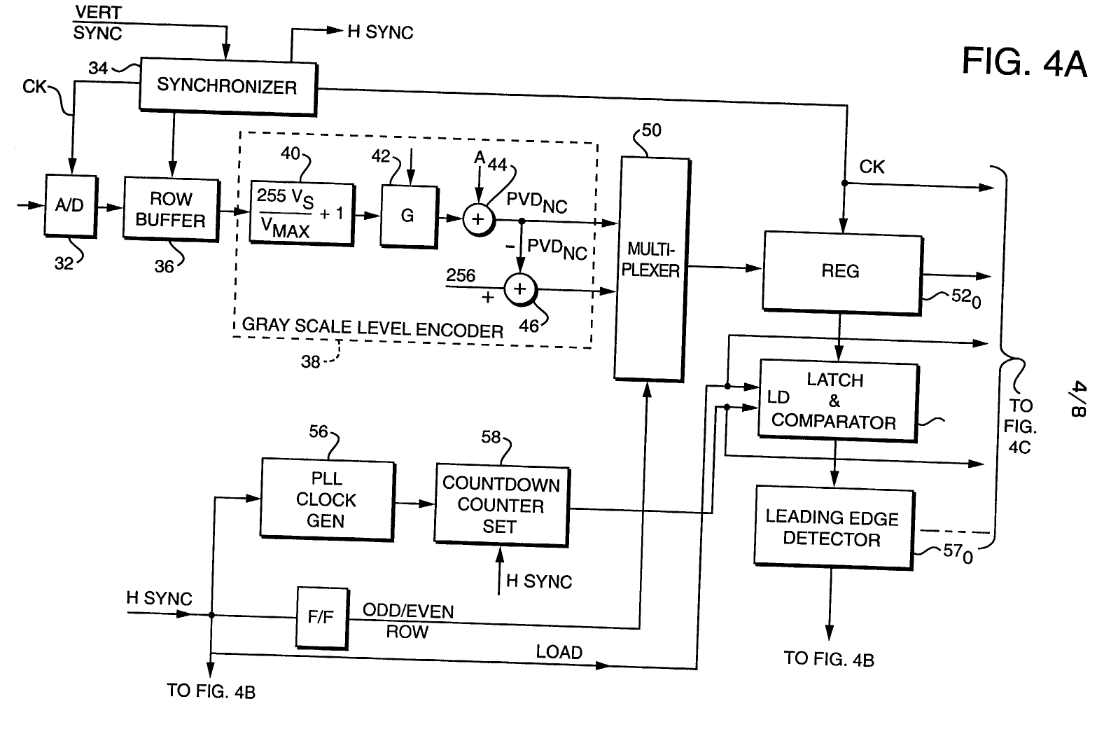

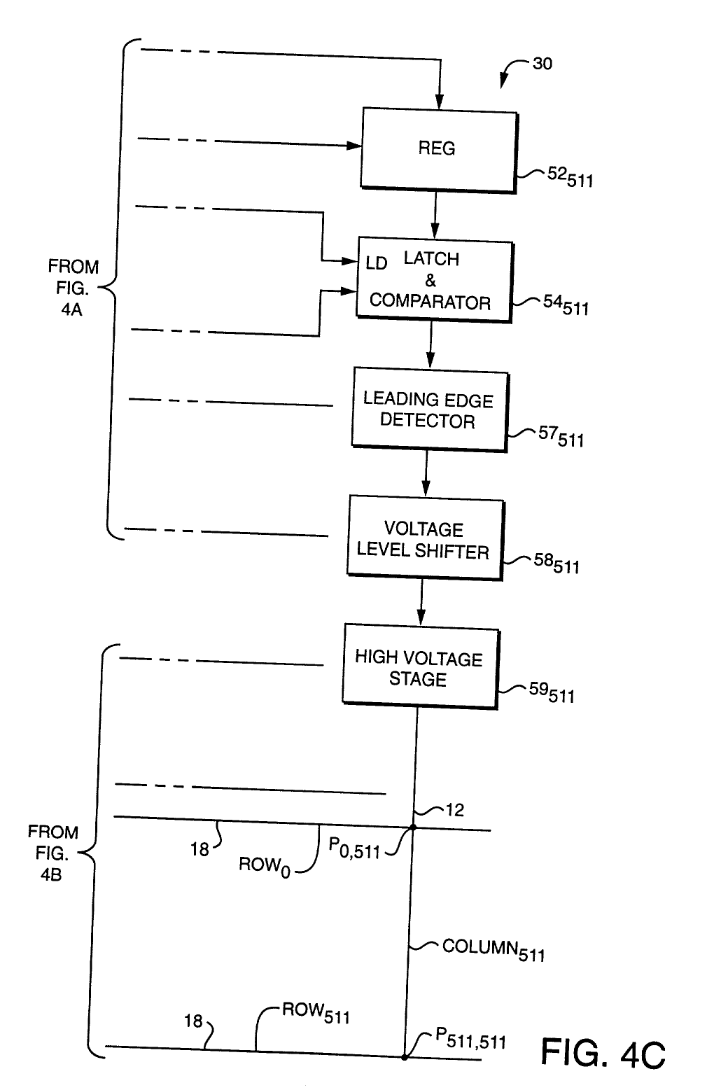

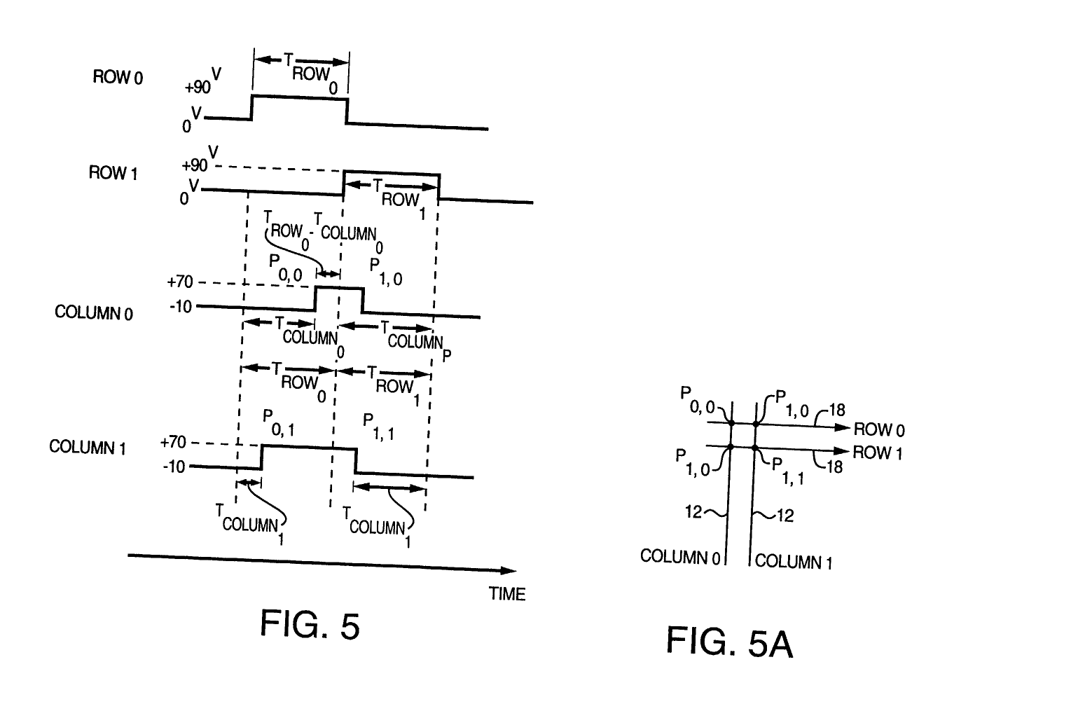

Thus, the field emission display (FED) 10 includes a plurality of pixels, P. Each pixel P includes a field emission cathode 12, a gate electrode 18, a focus grid 22, and a cathodoluminescent anode 14. Here, as described in U.S. Pat. No. 5,543,691, referred to above, each pixel, P, includes many field emitting tips 21, here typically 400 tips. The pixels, P, are arranged in a matrix of rows and columns (P_{ROW,COLUMN}) (FIGS. 1 and 5A). The cathodes 12 are connected in columns 12 (FIG. 3) and the gate electrodes 18 are connected in rows.

The cathode 12 is fabricated in accordance with the teachings of U.S. Pat. No. 4,908,539 entitled “Display Unit Cathodoluminescent Excited Cathodes and Display Means by Cathodoluminescence Excited Field Emission Using Said Source”, issued Jul. 10, 1990 and incorporated herein by reference. An exemplary one of the pixels, P_{ROW,COLUM}, is shown in FIG. 3. A glass substrate 26 is provided for the rear plate of the display 10. Disposed on the rear, glass plate 26 is one of the plurality of column conductors 12, here a composite conductor made up of a column conductor 12a disposed on the glass plate 26 and a resistive layer 12b disposed on the column conductor 12a. A triangular shaped, electrically conductive field emitter 24 is formed in the aperture of an insulating layer 28, as shown. One of the row conductors 18 is formed with an aperture 29 over the tip of the field emitter 24 to provide gate electrode 18. The focus grid electrode 20 is shown suspended over the gate electrode 18. The front glass plate 15 has a phosphor layer 16 formed thereon. An aluminum anode layer 17 is formed over the phosphor layer 16.

Here, the voltage on the anode 14 is either 8 KV to 10 KV, during normal operation, or 4 KV to 5 KV during night vision where less brightness is required for the display 10. The voltage at the anode 14 is selected for normal operation or night vision operation by either the operator or automatically by background light sensors, not shown. For example, here a voltage doubler power supply 27 produces two voltage levels at output ports 27a, 27b, respectively, thereof. Output port 27a produces a voltage of between 8 KV and 10 KV and output port 27b produces a voltage between 4 KV and 5 KV. The output ports 27a, 27b are fed to inputs of a switch 23. The output port 27c of switch 23 is fed to the anode 14, as shown, to thereby couple either 8 KV to 10 KV or 4 KV to 5 KV to the anode 14. As noted above, the switch 23 is controlled by either the operator or automatically by background light sensors, not shown.

As noted above the pixels, P_{ROW.COLUMN}, are arranged in a matrix of rows 18 and columns 12, as shown in FIG. 5A. Thus, a pixel at row, r, and column, c, may be designated as P_{r,c}. Each row, r, of pixels P is addressed by raising the voltage level on the gate electrodes 18 from ground to +90 volts. When a row, r, is addressed, pixels P in the addressed row, r, will emit electrons when the voltage at the column 12 of such pixel P is changed from +70 volts to −10 volts. That is, a pixel will emit electrons when the voltage at the cathode is at least 20 volts more negative than the voltage at the control electrode.

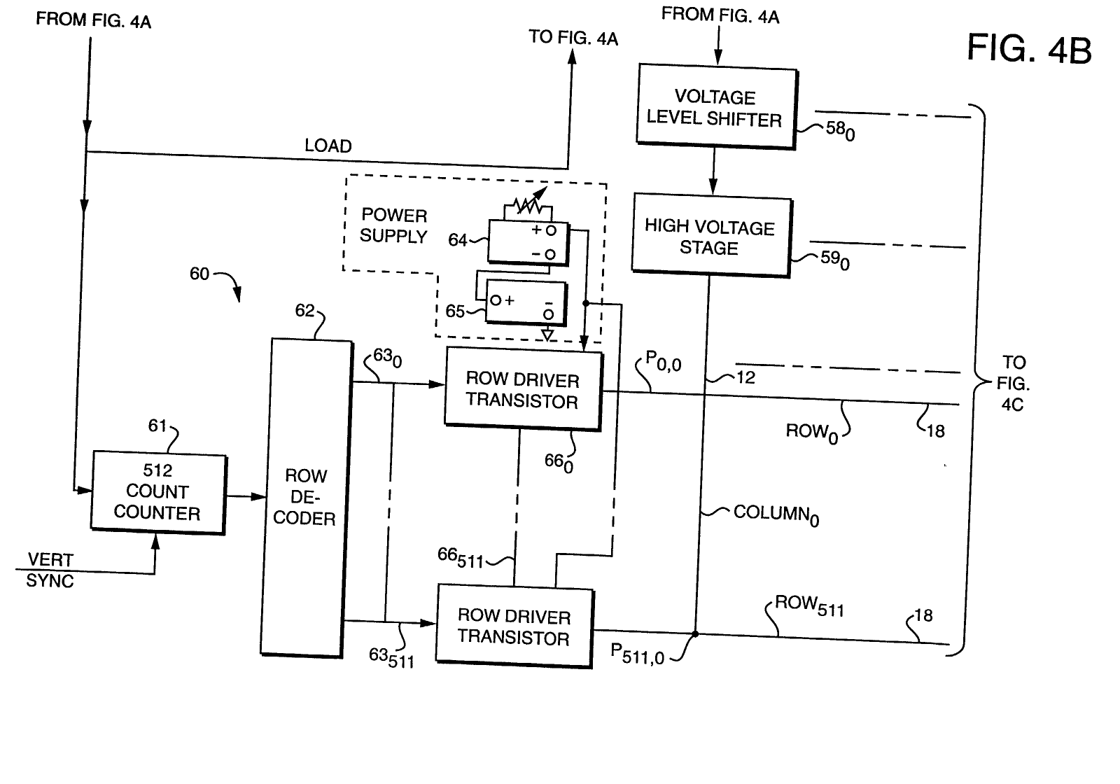

The row and column addressing is performed by drive electronic circuitry 30 to be described in detail in connection with FIG. 4. Suffice it to say here, however, that images are formed on the display 10 by successively addressing the rows 18 of pixels P. Each one of the rows 18 of pixels is addressed by raising the voltage at the gate electrodes in the addressed row from ground potential to +90 volts for a predetermined row addressing period of time, T_{ROW}.

For example, referring to FIGS. 5 and 5A, row0, is addressed during a first period of time T_{ROW0}=T_{ROW}, by increasing the voltage of the row conductor (i.e, gate 18) from 0 volts to +90 volts, as shown. It is noted that during this first period of time, T_{ROW0}, the voltages on all other row conductors 18 are zero volts. During this first period of time, T_{ROW0}, the voltage at column, column0 (FIG. 5A), is initially at −10 volts for a period of time T_{COLUMN0} after commencement of the addressing of the row0, thereby enabling electrons to pass to the corresponding point (i.e., pixel) on the anode 14, after which period of time T_{COLUMN0} the voltage on column0 changes (i.e., is raised positive) from −10 volts to +70 volts until termination of the row addressing period of time T_{ROW} thereby preventing electrons at the cathode of pixel P_{0,0} from passing to the corresponding point (i.e., pixel) on the anode 14 opposite pixel P_{0, 0} during the remaining portion of the row addressing period of time i.e., electrons are enabled to pass to the anode 14 for a period of time T_{COLUMN0}. The intensity produced by the anode 14 at such point is related to the time duration or period, T_{COLUMN0}, the voltage is maintained at −10 volts. Minimum intensity will be when T_{COLUMN0}=0, the maximum intensity will be when T_{COLUMN0}=T_{ROW}, 50% maximum intensity will be when T_{COLUMN0}=0.5T_{ROW}, etc. It is noted that when the row0 is addressed during the first period of time T_{ROW0}, pixel P_{0,0} will have an intensity related to period T_{COLUMN0}; pixel P_{0,1} will have an intensity related to period T_{COLUMN1}; etc.

During the second, succeeding period of time T_{ROW1}=T_{ROW}, the voltage at the first row of conductors, row0, changes from +90 volts to 0 volts and the voltage at the second row of conductors, row1, changes from 0 volts to +90 volts, as shown, thereby addressing the second row of pixel, row1 in FIG. 5A. It is first noted that when the second row1, of pixels is addressed during the second period of time T_{ROW1}, pixel P_{1,0} will have an intensity related to period T′_{COLUMN0}, i.e., the period of time column0 is at −10 volts; pixel P_{1,1} will have an intensity related to period T′_{COLUMN1}, i.e., the period of time column1 is at −10 volts; etc.

More particularly, during this second period of time, T_{ROW1}, the voltage at column1, is initially at +70 volts for a period of time T′_{ROW}-T′_{COLUMN0} after commencement of the addressing of the row1, thereby preventing electrons from passing to the corresponding point (i.e., pixel) on the anode 14, after which period of time (T′_{ROW}-T′_{COLUMN0}) the voltage on column0 changes (i.e., is lowered negatively) from +70 volts to −10 volts until termination of the row addressing period of time T_{ROW} thereby enabling electrons at pixel P_{1,0} to pass to the corresponding point (i.e., pixel) on the anode 14 opposite pixel P_{1,0} during the remaining portion of the row addressing period of time i.e., electrons are enabled to pass to the anode 14 for a period of time T′_{COLUMN0}. The intensity produced by the anode at such point is related to the time duration or period, T′_{COLUMN0}, the voltage is maintained at −10 volts. Again, minimum intensity will be when T′_{COLUMN0}=0 the maximum intensity will be when T′_{COLUMN0}=T_{ROW}, 50% maximum intensity will be when T_{COLUMN0}=0.5T_{ROW}, etc.

Thus, during each predetermined addressing period of time, T_{ROW}, a voltage level of −10 volts is applied to each one of the columns of pixels (i.e., to the cathodes) for time periods, T_{COLUMN}, where T_{COLUMN} ranges from 0 (maximum brightness) to T_{ROW} (minimum brightness (i.e., dimmest). The period of time, T_{COLUMN}=kT_{ROW}, where k is between 0 and 1, for each pixel is in accordance with the desired image level for such pixel (i.e., a gray scale video data intensity level). It is noted that, during the row addressing period of time, T_{ROW}, the voltage applied to the column 12 (i.e, cathodes) switches no more than once during each predetermined addressing period of time, T_{ROW}, thereby reducing power dissipation in the display when compared with a system which pulses the pixels during row addressing. That is, with a pulse, such pulse changes levels twice each addressing period. Because of capacitance effects on the columns, each time the level of the voltage fed to such column changes, power is dissipated. Therefore, by reducing the number of voltage level changes on the column during each row addressing period in half, i.e., from two voltage level changes to no more than one change voltage level change, power dissipation is reduced by a factor of 2.

Referring now to FIG. 4, the addressing drive circuitry 30 is shown to include an analog to digital converter 32 fed by an analog video signal, Vᵢₙ, representing the intensity of an image to be formed on the display 10 (i.e., pre-processed analog video data). The pre-processed analog video data is a voltage varying from Vᵢₙ=0 volts to a maximum voltage, Vᵢₙ=Vmax, here 0.7 volts. It is noted that Vᵢₙ=0 volts corresponds to the brightest pixel light intensity and Vᵢₙ=0.7 volts corresponds to the dimmest pixel light intensity.

The pre-processed analog video data is sampled by the A/D converter 32 and such samples are converted into N bit, here 8 bit, digital words by the A/D converter 32. Each sample is converted in response to clock pulses, CK, fed to the A/D converter 32 by a timing & control synchronizer 34. Here, the clock pulses are fed to the A/D converter 32 at a rate of [60 Hz/ROW_{MAX}]/(the number of pixels per row), where ROW_{MAX} is the number of rows to be addressed per video scan. Here, ROW_{MAX}=512 (i.e., row0-row511) and the number of pixels per row is here 512.

The digital samples produced by the A/D converter 32 are fed to a row buffer 36 which is synchronized by the timing & control synchronizer 34 in response to vertical sync pulses fed to the timing & control synchronizer 34 by the video signal source, not shown, such as a video camera. Each row of pre-processed video samples retrieved from the row buffer 36 is fed to a gray scale level encoder section 38. The gray scale level encoder section 38 includes a module 40 for converting each digital word produced by the row buffer 36 into one of 255 gray scale level ranging from a level 0 (the brightness level) to a level 255 (the dimmest level). For example, if the level of the sampled analog video signal is Vmax, the module 40 converts such video signal sample into a gray scale level of 255. If, for example, the sampled analog video signal is Vmax/2, the module 40 converts the video signal sample into a gray scale level of 127. If, for example, the sampled analog signal is Vmax/4, the module 40 converts the video sample into a gray scale level of 63. If, for example, the sampled analog signal is Vmin=0 volts, the module 40 converts the video sample into a gray scale level of 1. Thus, the module 40 conversion relationship between sampled analog video signal, Vs, and gray scale level (GSL) may be represented as:

GSL=GSL_{MAX}[Vs/Vmax], where here GSL_{MAX}=255

The gray scale level encoder section 38 also includes a module 42 for adjusting the gain of the display 10. Thus, the data produced by module 40 is multiplied by a factor G in gain module 42, where G is equal to or less than 1. The value of G is selected by the operator of the display 10 and such gain factor G is reduced or increased by the operator to obtain the desired display characteristic.

The output of gain module 42 is fed to a contrast module 44. Contrast module 42 includes an adder which shifts the gain adjusted gray scale level an amount A. The amount A is selected by the operator to obtain the desired contrast for the display 10. That is, contrast is the maximum brightness to minimum brightness (dimmest) range. Thus, if A=0, the contrast ranges from a maximum display 10 brightness to dimmest;i.e., the gray scale levels will range from the dimmest level, a gray scale level of 255, to the brightest level, a gray scale level of 0. However, if A is increased, the brightest level produced by the display 10 will be truncated to the level A. For example, if A is a gray scale of 5, the range from dimmest level of 255 to a brightest level of only 6 rather than 1. Thus, if A is greater than zero, T_{COLUMN} will range from A to T_{ROW}, thereby truncating the maximum brightness by A gray scale levels.

The resulting data produced at the output of gain module 42 is processed video data, PVD, as shown in FIG. 4. The gray scale level encoder section 38 includes a complement module 46 for determining the complement of the processed video data PVD. That is, the complement module 46 subtracts the processed video data PVD, herein sometimes designated as non-complemented processed video data, PVD_{nc}, produced by module 44 from the maximum gray scale level, GSL_{MAX}, here 255, to produce complemented processed video data PVD_{c}, as shown in FIG. 4. Thus, PVD_{nc}+PVD_{c}=GSL_{MAX}=255.

The non-complemented processed video data, PVD_{nc}, and the complemented processed video data, PVD_{c}, are fed to a multiplexer 50, as shown. The multiplexer 50 is controlled by a binary signal produced by a flip/flop 52. Flip/flop 52 is fed by a horizontal (i.e., row) sync signal produced by the timing & control synchronizer 34. More particularly, the timing & control synchronizer 34 produce a horizontal sync pulse at the initiation of each row addressing pixel, T_{ROW}. Thus, when the first row of pixels is addressed, the flip/flop 52 produces a first binary signal, say logic 0, and when the next row is addressed the logic state of the signal produced by the flip/flop 52 changes to, say logic 1. Thus, it follows that when, for example, the even rows, (i.e., row0, row2, row4, . . . row510) are addressed, the non-complemented processed video data, PVD_{nc}, are fed to the output of the multiplexer 50 and when the odd rows, (i.e., row1, row3, row5, . . . 511) are addressed, the complemented processed video data, PVD_{c}, are fed to the output of the multiplexer 50. Thus, as the rows, row0-row511, are successively addressed, the processed video data, PVD₀-PVD₅₁₁, are successively passed out of the multiplexer 50 in an “even row/odd row” interleaved manner; the non-complemented processed video data, PVD_{nc}, being passed out of multiplexer 50 when even rows, row0, row2, row4, etc., are addressed and the complemented processed video data, PVD_{c}, being passed out of the multiplexer 50 when the odd rows, row1, row3, etc. are addressed.

The output of the multiplexer 50 is fed to the first of a plurality of, here 512, serially coupled for storage in registers 52₀-52₅₁₁, as shown; each one of the registers 52₀-52₅₁₁ being coupled to columns column0-column511 of cathodes, respectively, as indicated. The registers 52₀-52₅₁₁ are fed clock pulses CK produced by the timing & control synchronizer 34. Thus, as the 512 processed video data, PVD₀-PVD₅₁₁, (either non-complemented processed video data, PVD_{nc}, when the even rows are addressed, or complemented video data, PVD_{c}, when the odd rows are addressed) for each addressed row are produced sequentially at the output of the multiplexer 50, they become sequentially stored in the registers 52₀-52₅₁₁; i.e. register 52₀ storing PVD₀ and register 52₅₁₁ storing PVD₅₁₁. Thus, at the end of the sequence, PVD₀-PVD₅₁₁ become stored in registers 52₀-52₅₁₁, respectively. The outputs of registers 52₀-52₅₁₁ are fed in parallel to the inputs of latch & comparators 54₀-54₅₁₁, respectively, as shown. Also fed to the latch & comparators 54₀-54₅₁₁, is a load signal produced by the horizontal sync pulse. The clock pulse generator 56 produces a series of clock pulses here 256 clock pulses in response to each horizontal sync pulse fed thereto, i.e., 256 clock pulses during the addressing of each one of the rows of pixels. The clock pulses produced by the clock pulse generator 56 are fed to a count-down counter 58. The counter 58 decrements by one from an initial, set, value of GSL_{MAX}, here 255, in response to each one of the clock pulses fed thereto. The count-down counter 58 is initially set to its initial count of 255 in response to a horizontal, i.e., row, sync pulse produced by the timing & control synchronizer 34. The contents of the count-down counter 58 are fed to one of the two inputs of the comparator portion of the latch & comparators 54₀-54₅₁₁, as shown, the other input to the comparator portion of the latch & comparators 54₀-54₅₁₁ being coupled to the outputs of the registers 52₀-52₅₁₁, respectively. The load input of the latch & comparators 54₀-54₅₁₁ are fed by the horizonal sync pulse, as indicated. Thus, in response to each horizontal sync pulse, (i.e., at the start of each row addressing period of time T_{ROW}, FIG. 5), the processed video data, PVD₀-PVD₅₁₁, stored in the registers 52₀-52₅₁₁ become stored in the latch portion of the latch & comparators 54₀-54₅₁₁. The video data stored in the latch portion of the latch & comparators 54₀-54₅₁₁ is compared with the count of the count-down counter 58. The output of the comparator portion of the latch & comparators 54₀-54₅₁₁ is here low, (i.e., a logic 0) when the count of the count-down counter 58 is less than the processed video data, PVD₀-PVD₅₁₁, stored in the latch portion of the latch & comparators 54₀-54₅₁₁, respectively, and is high, (i.e., a logic 1) when the count of the count-down counter 58 is greater than, or equal to, the processed video data, PVD₀-PVD₅₁₁, stored in the latch portion of the latch & comparators 54₀-54₅₁₁, respectively.

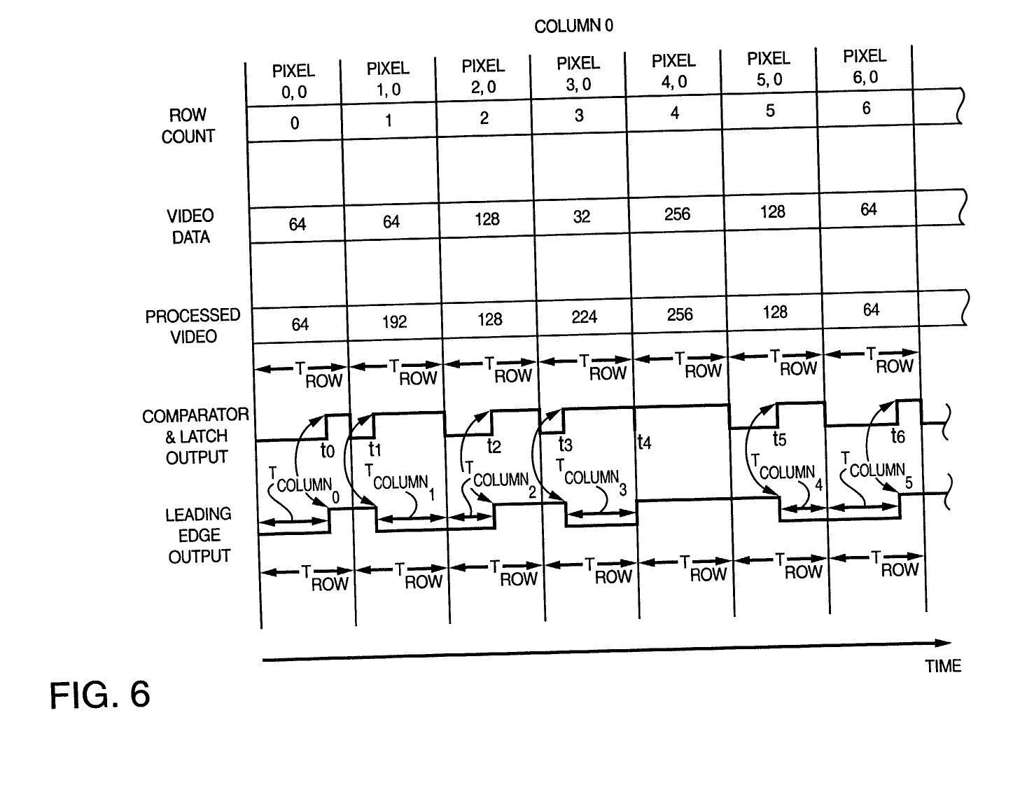

For example, referring to FIG. 6, here the processed, non-complemented video data, PVD_{nc}, for pixels P_{0,0}, P_{1,0}, P_{2,0}, P_{3,0}, P_{4,0}, P_{5,0}, P_{6,0} (i.e., the pixels in column0) are gray scale levels of 64, 64, 128, 32, 255, 128 and 64, respectively, and the complemented video data, PVD_{c}, for pixels P_{0,0}, P_{1,0}, P_{2,0}, P_{3,0}, P_{4,0}, P_{5,0}, P_{6,0} are gray scale levels of 192, 192, 128, 224, 0, 128 and 192, respectively. Here, the gain G and the contrast term A are assumed to be 1 and 0, respectively. The processed video data sequentially stored in register 52₀ (and then transferred to the latch portion of the latch & comparators 54₀-54₅₁₁) will be, because of the operation of the multiplexer 50 in response to the output of flip/flop 52, gray scale levels of 64, 192, 128, 224, 255, 128, 64, respectively, as indicated in FIG. 6.

The clock pulses fed to the count-down counter 58 are here at a rate 1/[T_{ROW}/GSL_{MAX}+1]=1/[T_{ROW}/256], where T_{ROW} is the period of time a row is addressed as described above in connection with FIG. 5. Thus, referring again to FIG. 6, during the time period when the first row of pixels is addressed, i.e., during the time period, T_{ROW}, and considering in this example the pixels at column0, (i.e., the pixel P_{0,0}, P_{1,0}, etc.) the video data stored in the latch portion of the latch & comparator 54₀ will be, as discussed above, 64, 192, 128, 224, 255, 128, 64, . . . At the commencement of the addressing of row0, the count-down counter 58 is reset by the horizontal sync pulse to 255, as noted above, to a count of 255. The counter 58 counts down from 255 until it reaches the contents stored in the latch portion of the latch & comparator 54₀. This will occur after 192 clock pulses have been counted. At that time, t₀, (i.e., after 192 clock pulses have been counted) the output of the comparator portion of the latch & comparator 54₀ changes state from a logic 0 to a logic 1, as shown in FIG. 6.

The pulses produced at the output of the latch & comparators 54₀-54₅₁₁ are fed to leading edge detectors 57₀-57₅₁₁, respectively, as shown. The output of the leading edge detectors 57₀-57₅₁₁ change logic state in response to the leading edge of a change in voltage level at the output of the latch & comparators 54₀-54₅₁₁, respectively, fed thereto. Thus, leading edge detector 57₀ changes its output voltage level at time t₀.

At the commencement of the addressing of the next row, i.e., row1, the count-down counter 58 is again set to 255 by the horizontal sync pulse. It is noted that the output of the latch & comparator 54₀ changes from a logic 0 to a logic 1 at time t₁. That is, during the addressing of the next row, i.e., row1, the count-down counter 58 decrements in response to the clock pulses fed thereto. When the contents of the count-down counter 58 reaches the count in the latch & comparator 54₀, now 192, here at time tₙ=t₁ after 64 clock pulses have been counted, the output of the latch & comparator switches from a logic 0 to a logic 1. In like manner, the latch & comparator 54₀ will change from a logic 0 to a logic 1 at times t₂, t₃, t₄, t₅, and t₆, for pixels P_{2,0}, P_{3,0}, P_{4,0}, P_{5,0}, P_{6,0}, respectively, after the count-down counter 58 has counted 128, 32, 0, 128, and 192 clock pulses, respectively. Thus, each one of the gray scale levels read from the registers 52₀-52₅₁₁ is converted into a time period commencing at a time tₙ after commencement of the addressing of each of the rows of pixels.

The output of the latch & comparator 54₀ is fed to the leading edge detector 57₀. The output of the leading edge detector 57₀ changes logic state in response to each leading edge of the pulse produced at the output of the latch & comparator 54₀. That is, when the output of the latch & comparator 54₀ changes from a logic 0 to a logic 1, the voltage at the output of the leading edge detector 57₀ changes from here 0 volts to 5 volts; otherwise the output of the leading edge detector 57₀ remains constant. Thus, it is noted that the output of the leading edge detector 57₀ switches from 0 volts to 5 volts at time, t₀, remains at 5 volts until time t₁ when it changes to 0 volts, remains at 0 volts until time t₂, at which time it changes to 5 volts. The process repeats with the voltage at the output of the leading edge detector 57₀ changing between 0 volts and 5 volts no more than once each for addressing period T_{ROW}, as shown and discussed above in connection with FIG. 5. Thus, during the addressing of the rows of pixels, the leading edge detector 57₀ switches between different voltage levels (i.e., between 0 volts and 5 volts) at the columns of pixels at the times tₙ, where n is here from 0 to 511.

That is, it is noted that pixel P_{0,0} is at −10 volts for a period of time T_{COLUMN0} during which time period electrons are allowed to pass to the anode 14. Thus, electrons are able to pass to the anode [(T_{COLUMN})/T_{ROW}] times 100 percent of the row addressing time period, T_{ROW}. Further, as noted above, the dimmest pixel will be where T_{COLUMN}=T_{ROW}. Thus, here pixels P_{0,1} to P_{0,6} produce intensities having the following percent of dimmest: 25% dimmest, 25% dimmest, 50% dimmest, 12.5% dimmest, 100% dimmest, 50% dimmest, and 25% dimmest, respectively. Thus, the percent dimmest is [T_{ROW}-T_{COLUMN}]/T_{ROW} times 100.

To put it another way, the output of the leading edge detectors 57₀-57₅₁₁ change logic state in response to the leading edge of a change in voltage level at the output of the latch & comparators 54₀-54₅₁₁, respectively, fed thereto. Thus, referring to FIG. 6, and considering column0, leading edge detector 57₀ changes from a low level to a high level after a period of time T_{COLUMN0} after the addressing of rowl. The leading edge detector 57₀ remains at the high state until the leading edge of the second row addressing pulse, i.e., at time T_{ROW}+T_{COLUMN1}, as shown, at which time the leading edge detector 57₀ changes to a low state. The leading edge detector 57₁ remains low for the remainder of the addressing of the second row of pixels, i.e., P_{1,0}. The process repeats as shown in FIG. 8. It is noted that for pixel, P_{4,0}, T_{COLUMN4}=0, the dimmest pixel. Thus, because the leading edge detector 57₀ changes state in response to only the leading edge of the voltage fed thereto, it follows that the state of the signal produced at the output of the leading edge detector 57₀ will change no more than once during the period of time T_{ROW}.

The outputs of the leading edge detectors 57₀-57₅₁₁ are fed to voltage level shifters 58₀-58₅₁₁, respectively, as shown. The outputs of voltage level shifters 58₀-58₅₁₁ are fed to high voltage column drivers 59₀-59₅₁₁, respectively, as shown. Here, the registers 52₀-52₅₁₁, latch & comparators 54₀-54₅₁₁, counter 58, leading edge detectors 57₀-57₅₁₁, voltage level shifters 58₀-58₅₁₁ and high voltage drivers 59₀-59₅₁₁ are a Supertex HV 622 column driver.

The drive circuitry 30 includes row addressing circuitry 60 to successively drive, that is enable, the successive addressing of the row0 to row 511 for the period of time TROW, discussed above in connection with FIG. 5. Thus, the row addressing circuitry 60 includes a counter 61 reset to zero in response to each horizontal sync pulse and incremented by one in response to each one of the horizontal sync pulses. The count in the counter is fed to a row decoder 62 which successively produces a 5 volt level on the 512 output lines 63₀-63₅₁₁ thereof. Thus, after being reset to zero, only output 63₀ produces a 5 volt level, all other outputs 63₁-63₅₁₁ producing a zero volt level. In response to the next horizontal sync pulse, the 5 volts at output 63₀ becomes zero volts, the output 63₁ becomes 5 volts and the other outputs 63₂-63₅₁₁ remain at 0 volts. Thus, it follows that the outputs 63₀-63₅₁₁ successively produce a 5 volt signal.

The outputs 63₀-63₅₁₁ are fed to row driver power transistors 66₀-66₅₁₁, respectively, as shown. The outputs of the row driver power transistors 66₀-66₅₁₁ are coupled to row0-row 511, respectively, i.e., to the rows of gate electrodes 18, as shown. In response to a 5 volt signal fed to one of the row driver power transistors 66₀-66₅₁₁ by one of the outputs 63₀-63₅₁₁, respectively, fed thereto, the row driver power transistors 66₀-66₅₁₁ changes its output from zero volts to +90 volts, thereby enabling or addressing the row coupled thereto. It follows that the rows, row0-row511 become successively addressed as described in connection with FIG. 5.

It is noted that the power supply 64 has a bias supply 65 so that if it is desired that the voltage produced by the power supply 64, which is used to power the row driver power transistors 66₀-66₅₁₁, is to change between V_{bias} volts and V_{bias} +90 volts, the bias supply 65 may be used to provide the bias voltage V_{bias}.

Consider now the case where the contrast term A is 5, for example. With the same pre-processed video data used in the example discussed above, i.e., the non-complemented video data for pixels P_{0,0}, P_{1,0}, P_{2,0}, P_{3,0}, P_{4,0}, P_{5,0}, P_{6,0} (i.e., the pixels in column0) are gray scale levels of 64, 64, 128, 32, 255, 128 and 64, respectively, and the complemented video data for pixels P_{0,0}, P_{1,0}, P_{2,0}, P_{3,0}, P_{4,0}, P_{5,0}, P_{6,0} are gray scale levels of 192, 192, 128, 224, 0, 128 and 192, respectively. Here, assume the gain G=1 and the contrast term A=5. The processed video data sequentially stored in register 54₀ (and then transferred to the latch portion of the latch & comparator 54₀) will be, because of the operation of the multiplexer 50 in response to the output of flip/flop 56, gray scale levels of 64+5=69, 255−(64+5)=187, 128+5=132, 255−(32+5)=219, 255+5=261, 123, 69, respectively. Thus, the contrast term shift the gray scale level an amount, A.

The clock pulses fed to the count-down counter 58 are here at the rate 1/[T_{ROW}/GSL_{MAX}+1]=1/[T_{ROW}/256], where T_{ROW} is the period of time a row is addressed as described above. Thus, the register 52₀ will store a level of 59, instead of 56 for pixel P_{0,0}. The count-down counter 58 will now have to count down 5 fewer counts before reaching 59. Thus, the output of the latch & comparator 54₀ will change from a logic 0 to a logic 1 after only 197 counts, i.e. T_{COLUMN} will be 187 instead of 192. Likewise, for pixel P_{1,0} the data stored in register 52₀ will be 187, instead of 192. The count-down will reach the count of 187 after an additional five counts. Thus, the output of the leading edge detector 57₀ will change from a logic 0 to a logic 1 after 5 additional counts. A similar process results to pixels P_{2,0} through P_{511,0}.

The leading edge detector 57₀ will change between a 0 volt level and a 5 volt level after the first 197 counts from the commencement of the addressing of the first row of pixels and will change to a 0 volt level after 192 counts after the commencement of the addressing of the second row of pixels. Further, it is noted that for pixel P_{4,0} adding a count of 5 to 261 will still result in the count-down counter 58 reaching the count of 261 at the commencement of the row addressing so that such pixel will be 100% dimmest. It is next noted that for pixel P_{0,0}, [T_{ROW}-T_{COLUMN0}]/T_{ROW} is [256-187]/256=0.27 or now only 27 percent of dimmest. It follows then that the range of brightest to dimmest has been truncated by the term A, at least for pixels having percent dimmest levels greater than [5/256] times 100 percent. It is next noted that for pixel P_{1,0}, [T_{ROW}-T_{COLUMN}]/T_{ROW} is also [256-187)]/256=0.27 of 27% dimmest. Thus, for a pre-processed video levels having the same percentage brightness, the display of such brightness is the same for complemented or non-complemented processing of such video data.

To put it another way, a method is provided for forming images on display 10 having a matrix of rows and columns of pixels, P_{0,0}-P_{511,511}. The images are characterized by a gray scale level at each one of the pixels. First, a series of streams of video data samples are produced by the A/D converter 32. Each stream in the series represents intensity levels of pixels in a corresponding one of the rows of pixels. Each video data sample in the stream represents the intensity level of a corresponding one of the columns of pixels in such corresponding one of the rows of pixels. Next, each produced video data sample is converted by module 38 into a gray scale level represented by a N bit digital word, where N is an integer, to produce a non-complemented gray scale level (NCGSL). Simultaneously, each produced video data sample is converted by module 38 (i.,e, adder 46) into a gray scale level represented by a N bit digital word, where N is an integer, to produce a complemented gray scale level (i.e., GSL_{MAX}-NCGSC, where GSL_{MAX} is the maximum gray scale level over which the video data is segmented or resolved). The streams of produced non-complemented gray scale levels in first ones of the produced series (i.e., even rows of pixels, for example, P_{0,0}-P_{0,511}) thereof are successively stored in registers 52₀-52₅₁₁ and the streams of produced complementary gray scale levels in second ones of the produced series thereof (i.e., odd rows of pixels, for example, P_{1,0}-P_{1,511}) are successively stored in the registers 52₀-52₅₁₁. The first ones of the series are then interleaved with the second series thereof. The rows of pixels are successively addressed by row addressing pulses during periods of time, T_{ROW0}, T_{ROW1}, etc. Thus, each one of the rows of pixels is addressed for a predetermined period of time, T_{ROW}. The stored first and second series of gray scale levels are read from the registers 52₀-52₅₁₁ in parallel; the reading of the first series being interleaved with the reading of the second series. Each one of the read, gray scale levels is converted into a time period, T_{COLUMN}. The time period commences at commencement of the addressing of each one of the rows (here, the even rows, row0, row2, etc.) of pixels and terminates at a time, T_{ROW}-T_{COLUMN}, after the commencement of the addressing of the next one of the rows of pixels (i.e., here, the odd rows row1, row3, etc.). Thus, in this way, the voltage levels produced at the columns of pixels are switched between different levels no more than once during the row addressing period, T_{ROW}.

Other embodiments are within the spirit and scope of the appended claims.

What is claimed is:

1. A method for forming images on a display having a matrix of rows and columns of pixels, such method comprising the steps of:
successively addressing the rows of pixels, each one of the rows of pixels being addressed for a predetermined addressing period of time;
during each predetermined addressing period of time, applying a voltage level to each one of the columns of pixels for a time duration in accordance with image intensity data and changing to a different voltage level during the remaining period of the addressing period of time, the voltage level changing no more than once during each predetermined addressing period of time.

2. A method for forming images on a display having a matrix of rows and columns of pixels, such-method comprising the steps of:
successively addressing the rows of pixels, each one of the rows of pixels being addressed for a predetermined period of time, T_{ROW};
during each predetermined period of time, T_{ROW}, applying a voltage level to each one of the columns of pixels for a time duration kT_{ROW}, where k is less than 1, in accordance with image intensity data and changing to a different voltage level during the remaining period of the predetermined period of time, T_{ROW}, the time duration kT_{ROW} commencing at the beginning of the predetermined period of time, T_{ROW}, for one of the rows of pixels and the time duration kT_{ROW} terminating at the termination of the predetermined period of time, T_{ROW}, for the next addressed row of pixels.

3. A method for forming images on a display having a matrix of rows and columns of pixels, such images being characterized by a gray scale level at each one of the pixels, such method comprising the steps of:
producing a series of streams of video data samples, each stream in the series representing intensity levels of pixels in a corresponding one of the rows of pixels, each video data sample in the stream representing the intensity level of a corresponding one of the columns of pixels in such corresponding one of the rows of pixels;
converting each produced video data sample into a gray scale level represented by a N bit digital word, where N is an integer, to produce a non-complemented gray scale level, and for converting each produced video data sample into the complement of such N bit digital word to produce a complement gray scale level;
successively storing the streams of produced non-complemented gray scale levels in first ones of the produced series thereof and successively storing the streams of produced complementary gray scale levels in second ones of the produced series thereof, the first ones of the series being interleaved with the second series thereof;
successively addressing the rows of pixels, each one of the rows of pixels being addressed for a predetermined period of time, T_{ROW};
reading the stored first and second series of digital words, the reading of the first series being interleaved with the reading of the second series;
converting each one of the read digital words into a time period, T_{COLUMN}, such time period commencing at a time, tn, after commencement of the addressing of each of the rows of pixels;
during the addressing of the rows of pixels, switching between different voltage levels produced at the columns of pixels at the time, tn, during each of the row addressing periods of time T_{ROW}.

4. A method for forming images on a display having a matrix of rows and columns of pixels, such images being characterized by a gray scale level at each one of the pixels, such method comprising the steps of:
producing a series of streams of video data samples, each stream in the series representing intensity levels of pixels in a corresponding one of the rows of pixels, each video data sample in the stream representing the intensity level of a corresponding one of the columns of pixels in such corresponding one of the rows of pixels;
converting each produced video data sample into a gray scale level represented by a N bit digital word, where N is an integer, to produce a non-complemented gray scale level, and for converting each produced video data sample into the complement of such N bit digital word to produce a complement gray scale level;
successively storing the streams of produced non-complemented gray scale levels in first ones of the produced series thereof and successively storing the streams of produced complementary gray scale levels in second ones of the produced series thereof, the first ones of the series being interleaved with the second series thereof;
successively addressing the rows of pixels, each one of the rows of pixels being addressed for a predetermined period of time, T_{ROW};
reading the stored first and second series of digital words, the reading of the first series being interleaved with the reading of the second series;
converting each one of the read digital words into a time period, T_{COLUMN}, such time period commencing at a time, tn, after commencement of the addressing of each of the rows of pixels;
during the addressing of the rows of pixels, switching between different voltage levels produced at the columns of pixels at the time, tn, during each of the row addressing periods of time T_{ROW}.

5. A field emission display, comprising:
an array of field emitting cathodes;
a cathodoluminescent anode;
an array of control electrodes, each one of the gate electrodes controlling the flow of electrons between a corresponding one of the cathodes and a pixel on the cathodoluminescent anode;
a power supply adapted to couple either a relatively high voltage to the anode when such display is to operate in a relatively bright environment or a relatively low voltage when such display is to operate with relatively dim environment.

6. A method for forming images on a display having a matrix of rows and columns of pixels, the images being characterized by a gray scale level at each one of the pixels, comprising the steps of:
producing a series of streams of video data samples, each stream in the series represents intensity levels of pixels in a corresponding one of the rows of pixels, each video data sample in the stream represents the intensity level of a corresponding one of the columns of pixels in such corresponding one of the rows of pixels;
converting each produced video data sample into a gray scale level;
modifying the gray scale level by an contrast term.

7. The method recited in claim 6 wherein the modifying step includes the step of shifting the gray scale level by the contrast term.

8. A field emission display, comprising:
an array of field emitting cathodes;
a cathodoluminescent anode;
an array of control electrodes, each one of the gate electrodes controlling the flow of electrons between the a corresponding one of the cathodes and a pixel on the cathodoluminescent anode, each one of the pixels including one of the cathodes, a corresponding one of the control electrodes and a corresponding anode pixel,
wherein each one of the display pixels produces a light intensity in accordance with video data fed to the display; and
circuitry for modifying the video data fed to the display modified by contrast terms, such modified video data being used by the circuity to control the intensity of the pixels.

9. a method for forming images on a display having a matrix of rows and columns of pixels, the images being characterized by a gray scale level at each one of the pixels, comprising the steps of:
producing a series of streams of video data samples, each stream in the series represents intensity levels of pixels in a corresponding one of the rows of pixels, each video data sample in the stream representing the intensity level of a corresponding one of the columns of pixels in such corresponding one of the rows of pixels;
converting each produced video data sample into a gray scale level having a maximum gray scale level, GSL_{MAX}, to produce a non-complemented gray scale level and also converting each produced video data sample into the complement of such non-complemented gray scale level by subtracting the non-complemented gray scale level from GSL_{MAX};
successively storing the streams of produced non-complemented gray scale levels in first ones of the streams thereof during the addressing of a first set of rows of pixels and successively storing the streams of produced complementary gray scale levels in second ones of the produced series during the addressing of a second set of rows of pixels, the rows of pixels in the first set being interleaved with the rows of pixels in the second set;
successively addressing the rows of pixels, each one of the rows of pixels being addressed for a predetermined period of time, T_{ROW}, the stored first and second series of gray scale levels being read from storage, the reading of the first series being interleaved with the reading of the second series;
converting each one of the read gray scale levels into a time period, T_{COLUMN}, such time period commencing at a time, tₙ, after commencement of the addressing of each of the rows of pixels;
during the addressing of the rows of pixels, switching a voltage level produced at the columns of pixels at the time, tₙ, during each of the row addressing periods of time T_{ROW}.
